(19) United States
(12) Patent Application Publication
(10) Pub. No.: US 2010/0327828 A1
(43) Pub. Date: Dec. 30, 2010

(54) MOSFET CURRENT LIMITING CIRCUIT, LINEAR VOLTAGE REGULATOR AND VOLTAGE CONVERTING CIRCUIT

(75) Inventors: Li-Min Lee, Taipei County (TW); Zhong-Wei Liu, Wuxi (CN); Chung-Che Yu, Taipei County (TW); Shian-Sung Shiu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: GREEN SOLUTION TECHNOLOGY CO., LTD., Taipei County (TW)

(21) Appl. No.: 12/607,967

(22) Filed: Oct. 28, 2009

(30) Foreign Application Priority Data
Jun. 30, 2009 (TW) 98121936

(51) Int. Cl. G05F 1/00

(52) U.S. Cl. 323/273

(57) ABSTRACT

A MOSFET current limiting circuit, a linear voltage regulator, and a voltage converting circuit are provided. A current limiting value of the MOSFET is adjusted with the temperature or the voltage drop across the drain and the source of the MOSFET. Accordingly, it is ensured that the MOSFET operates in the safe operating area in any situation. Therefore, the MOSFET is prevented from being burnt out, and the reliability thereof is also increased.

### CROSS-REFERENCE TO RELATED APPLICATION

This application claims the priority benefit of Taiwan application serial no. 98121936, filed on Jun. 30, 2009. The entirety of the above-mentioned patent application is hereby incorporated by reference herein and made a part of specification.

### BACKGROUND OF THE INVENTION

1. Field of the Invention

The invention generally relates to a metal-oxide-semiconductor field effect transistor (MOSFET) current limiting circuit, a linear voltage regulator, and a voltage converting circuit. More particularly, the invention relates to a MOSFET current limiting circuit, a linear voltage regulator, and a voltage converting circuit of which the current limitation value is adjusted with the temperature and/or the voltage drop across the drain and the source of the MOSFET.

2. Description of Related Art

A semiconductor device usually has a safe operating area (SOA) to operate therein. When the semiconductor device is applied in a circuit, if the design of the circuit is unsuitable, the semiconductor device may operate outside the SOA. As a result, the reliability of the semiconductor device is reduced, and even the semiconductor device may be damaged. Generally, the SOA of the semiconductor device is determined according to the maximum current, the maximum power, and the maximum voltage that it can withstand. FIG. 1 is a schematic diagram illustrating an ideal SOA, i.e. the ideal SOA obtained in specific conditions, and a practical SOA of a conventional n-type MOSFET. Referring to FIG. 1, the dotted line represents the ideal SOA. However, since the semiconductor device may be applied in different situations, the SOA thereof is reduced to the practical SOA, represented by the solid line, due to the effects of the electricity and the thermology thereof.

FIG. 2 is a schematic cross-sectional view of the n-type MOSFET. Referring to FIG. 2, the source S and the drain D are n-type doped regions, and the region under the gate G and the silicon dioxide layer (i.e. the shadow region in FIG. 2), and the substrate B are p-type doped regions. Accordingly, a bipolar junction transistor (BJT) is formed. Generally, in order to prevent the BJT from affecting the n-type MOSFET, the substrate B and the source S of the n-type MOSFET are coupled to a common voltage. The BJT does not work because its base and emitter have the same voltage level.

When the voltage of the gate G of the n-type MOSFET is raised above a threshold voltage, the n-type MOSFET is turned on, so that a channel is formed in the p-type region under the gate G. Accordingly, electrons pass from the source S to the drain D through the channel to form a current IDS. When the voltage of the drain D is raised, a portion of the channel near the drain D may vanish, i.e. pinch-off. As a result, after being injected into the pinch-off region from the end of the channel, the electrons are sucked to the drain D due to the electric field. At this time, the n-type MOSFET operates in the saturation mode, the current IDS is maintained at a stable current value and no longer increased with the raise of the voltage of the drain D. When these hot electrons having high energy are injected into the pinch-off region, electron-hole pairs are generated due to the hot electrons colliding with silicon atoms. The electrons generated by colliding flow to the drain D due to the electric field, so as to form the collector current IC of the parasitic BJT. The holes generated by colliding flow to the substrate B and the source S due to the electric field, so as to respectively form the base current IB of the BJT and a leakage current Isub of the n-type MOSFET. When the leakage current Isub flows to the substrate B of the n-type MOSFET through the base Bb of the parasitic BJT, a voltage drop is formed due to the substrate resistor Rsub.

When the voltage of the drain D is further raised, the leakage current Isub also increases therewith since the electron-hole pairs generated due to the hot electrons colliding with silicon atoms are increased. Finally, when the voltage drop formed due to the leakage current Isub flowing through the substrate resistor Rsub reaches to the cut-in voltage, the parasitic BJT starts to operate. A part of the electrons enter the parasitic BJT from the source S, so as to form the emitter current IE. Moreover, the emitter current IE flows to the drain D through the parasitic BJT, so that the current flowing between the drain D and the source S increases. The electrons entering the parasitic BJT also may collide with silicon atoms, so that more electron-hole pairs are generated, and the current flowing between the drain D and the source S further increases. Accordingly, a positive feedback is formed, and thus avalanche breakdown appears in the n-type MOSFET.

Next, after avalanche breakdown, a lot of electrons flow through the parasitic BJT to generate a lot of heat, so the temperature of the BJT increases. Furthermore, the cut-in voltage of the parasitic BJT is reduced due to temperature increasing, so that more current is generated. It is unavoidable that the electrons flowing through the parasitic BJT do not uniformly distribute. As a result, the temperature does not uniformly distribute, either. The region where the temperature is higher has lower resistance, so that the electrons focus here. The temperature in the region is raised very fast due to the electrons focusing on the region, and eventually the semiconductor is burnt out.

As in the above description, when an electrical product, especially a power device, is applied in different situations, the SOA of the semiconductor device inside the electrical product may be reduced. It is possible that the semiconductor device inside the electrical product operates outside the practical SOA and thus is damaged. Accordingly, the reliability of the electrical product is reduced, and further the safety thereof is affected.

### SUMMARY OF THE INVENTION

The reduced SOA of the semiconductor device which reduces the reliability of the electrical product and further affects the safety thereof in the related art. In order to solve the issue, an embodiment of the invention discloses a MOSFET current limiting circuit, a linear voltage regulator, and a voltage converting circuit. By detecting the voltage and the temperature of the semiconductor device, the current limitation value is adjusted, so that it is ensured that the semiconductor device operates in the SOA.

An embodiment of the present embodiment provides a MOSFET current limiting circuit including a MOSFET driving unit and a current limiting unit. The MOSFET driving unit is coupled to a MOSFET and controls a state of the MOSFET. The current limiting unit is configured to limit a current flowing through the MOSFET inside a current limiting value, wherein the current limiting value is adjusted according to a voltage drop across a drain and a source of the MOSFET.

An embodiment of the present embodiment also provides a linear voltage regulator having a current limitation. The linear voltage regulator includes a MOSFET unit, a voltage feedback unit, a driving unit, and a voltage detecting unit. The MOSFET unit is coupled to an input voltage and generates an output voltage according to a control signal. The voltage feedback unit is configured to detect the output voltage to generate a voltage feedback signal. The driving unit is configured to generate the control signal to stabilize the output voltage value at a predetermined output voltage value according to the voltage feedback signal. The voltage detecting unit generates a voltage detecting signal according to the input voltage. The current limiting unit controls the driving unit to limit a current of the MOSFET unit inside a current limiting value, wherein the current limiting value is adjusted according to the voltage detecting signal.

An embodiment of the present embodiment further provides a voltage converting circuit having a current limitation. The voltage converting circuit includes a converting circuit, a voltage feedback unit, a MOSFET unit, and a control unit. The converting circuit is configured to convert an input voltage to an output voltage. The voltage feedback unit is configured to detect the output voltage to generate a voltage feedback signal. The MOSFET unit is coupled to the converting circuit. The control unit controls the MOSFET unit to decide an amount of electric power inputted from the input voltage to the converting circuit according to the voltage feedback signal and to limit a current flowing through the MOSFET unit inside a current limiting value, wherein the current limiting value is adjusted according to a temperature of the control unit or the MOSFET unit.

It is to be understood that both the foregoing general description and the following detailed description are exemplary, and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an ideal SOA and a practical SOA of a conventional n-type MOSFET.

FIG. 2 is a schematic cross-sectional view of the n-type MOSFET.

FIG. 3 is a schematic circuit of a voltage converting circuit having a current limitation according to a first embodiment consistent with the invention.

FIG. 4 is a schematic circuit of a voltage converting circuit having a current limitation according to a second embodiment consistent with the invention.

FIG. 5 is a schematic diagram illustrating that the predetermined current limiting value changes with the temperature and the voltage drop across the drain and the source of the MOSFET unit.

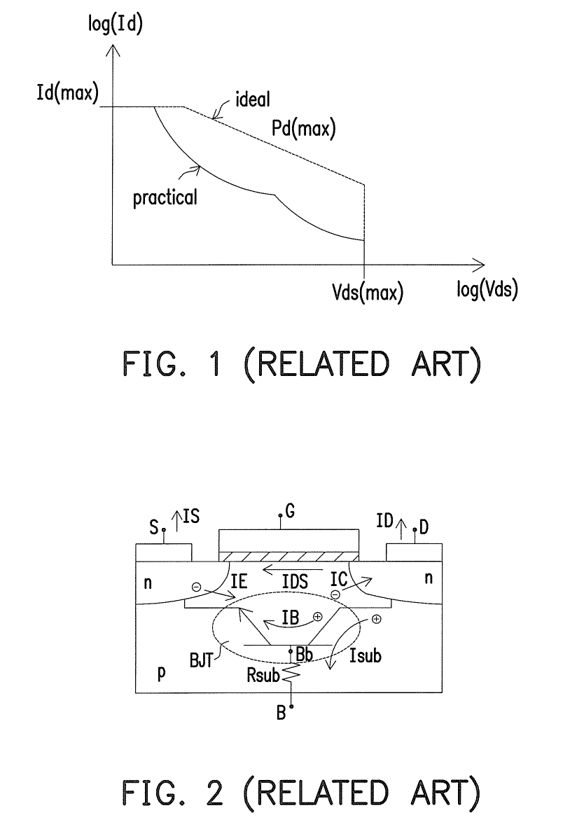

### DESCRIPTION OF EMBODIMENTS

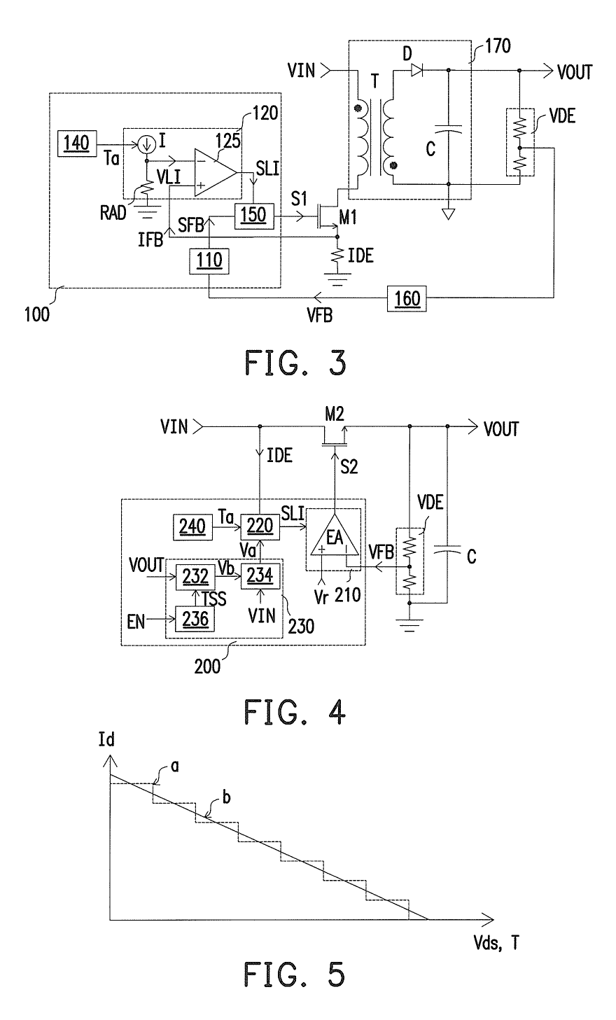

FIG. 3 is a schematic circuit of a voltage converting circuit having a current limitation according to a first embodiment consistent with the invention. Referring to FIG. 3, in the present embodiment, the voltage converting circuit is a flyback voltage converting circuit. The voltage converting circuit includes a MOSFET unit M1, a voltage feedback unit VDE, a current feedback unit IDE, a control unit 100, an isolating unit 160, and a converting circuit 170. The converting circuit 170 includes a transformer T, a rectifying diode D, an output capacitor C, wherein the converting circuit 170 is configured to convert an input voltage VIN to an output voltage VOUT. The primary side of the transformer T is coupled to the input voltage VIN. The output voltage VOUT is generated on the secondary side thereof after being rectified by the rectifying diode D. The output capacitor C is coupled to the secondary side of the transformer T to stabilize the output voltage VOUT. The voltage feedback unit VDE is coupled to the secondary side of the transformer T to detect the output voltage VOUT, and generates a voltage feedback signal VFB through the isolating unit 160. The isolating unit 160 is mainly used to isolate the primary side and the secondary side of the transformer T, so that the voltage converting circuit satisfies safety regulation. Accordingly, for some application, the isolating unit 160 may be unnecessary. The MOSFET unit M1 is coupled to the primary side of the transformer T and switched according to a control signal S1, so as to control electric power transmitted from the primary side of the transformer T to the secondary side thereof. In the present embodiment, the MOSFET unit M1 is an n-type MOSFET. The current feedback unit IDE is coupled to the MOSFET unit M1 to detect a current flowing through the MOSFET unit M1 to generate a current feedback signal IFB.

The control unit 100 includes a feedback unit 110, a current limiting unit 120, a temperature detecting unit 140, and a driving unit 150. The control unit 100 generates the control signal S1 to control the MOSFET unit M1 according to the current feedback signal IFB and the voltage feedback signal VFB. The feedback unit 110 is coupled to the voltage feedback unit VDE and generates a feedback control signal SFB to the driving unit 150 according to the voltage feedback signal VFB. The temperature detecting unit 140 detects a temperature of the MOSFET unit M1 to generate a temperature detecting signal Ta. The current limiting unit 120 receives the temperature detecting signal and controls an amount of a current provided by a current source I according thereto, so that the amount of the current provided by the current source I becomes smaller while the temperature is raised. After the current provided by the current source I flows through a current limiting resistor RAD, the current source I generates a current limiting reference signal VLI to an inverting input end of a comparator 125 in the current limiting unit 120. Moreover, a non-inverting input end of the comparator 125 receives the current feedback signal IFB, and an output end thereof generates a current limiting signal SLI to the driving unit 150. The driving unit 150 stabilizes the output voltage VOUT around a predetermined output voltage value according to the feedback control signal SFB, and the driving unit 150 limits the maximum current flowing through the MOSFET unit M1 according to the current limiting signal SLI, so that the maximum current flowing through the MOSFET unit M1 does not exceed a current limiting value.

When the temperature of the MOSFET unit M1 is raised, the amount of the current provided by the current source I falls down, so that the voltage level of the current limiting reference signal VLI falls down, and the current limiting value of the MOSFET unit M1 is further adjusted down. As a result, it is ensured that the MOSFET unit M1 operates in the SOA even if the temperature of the MOSFET unit M1 is raised. Accordingly, the MOSFET unit M1 is prevented from being burnt out.

In practice, the temperature detecting unit 140 may detect the temperature of the control unit 100 instead of the MOSFET unit M1, so as to generate the temperature detecting signal Ta. If the MOSFET unit M1 is an external device, and is not integrated inside a chip with the control unit 100, the control unit 100 and the MOSFET unit M1 are generally designed in the same system in practice. Accordingly, there is a temperature difference between the control unit 100 and the MOSFET unit M1 and a variation of the temperature difference is small. That is, there is an offset between the temperatures of the control unit 100 and the MOSFET unit M1, the temperature of the MOSFET unit M1 is indirectly obtained by adding the offset with the temperature of the control unit 100. If the MOSFET unit M1 and the control unit 100 are in the same chip or in the same package, the temperature difference between the control unit 100 and the MOSFET unit M1 is smaller and more stable, so that the temperature of the MOSFET unit M1 is also obtained by modifying the detected temperature for the offset.

Moreover, the current limiting resistor RAD may be externally connected to adjust the current limiting value for operating with the different MOSFET unit M1 in coordination.

FIG. 4 is a schematic circuit of a voltage converting circuit having a current limitation according to a second embodiment consistent with the invention. Referring to FIG. 4, in the present embodiment, the voltage converting circuit is a linear voltage regulator, such as linear dropout regulator (LDO), which includes a MOSFET unit M2, an output capacitor C, a voltage feedback unit VDE, and a control unit 200. The voltage feedback unit VDE is coupled to an output voltage VOUT to generate a voltage feedback signal VFB. In the present embodiment, the MOSFET unit M2 is an n-type MOSFET of which one end is coupled to an input voltage VIN. The control unit 200 outputs a control signal S2 to adjust the equivalent resistance of the MOSFET unit M2 according to the voltage feedback signal VFB, so that another end of the MOSFET unit M2 outputs the output voltage VOUT, and the output voltage VOUT is stable at a predetermined output voltage value. The output capacitor C is coupled to the output voltage VOUT to filter the high frequency noises of the output voltage VOUT.

The control unit 200 includes a driving unit 210, a current limiting unit 220, a voltage detecting unit 230, and a temperature detecting unit 240. The driving unit 210 includes an error amplifier of which the inverting end receives the voltage feedback signal VFB, and the non-inverting end receives a reference signal Vr. Accordingly, the driving unit 210 adjusts the voltage level of the control signal S2 to adjust the equivalent resistance of the MOSFET unit M2. The voltage detecting unit 230 generates a voltage detecting signal Va according to the input voltage VIN, the output voltage VOUT, and an enabling signal EN. The temperature detecting unit 240 detects the temperature of the MOSFET unit M2 or the control unit 200 to generate a temperature detecting signal Ta. The current limiting unit 220 receives a current detecting signal IDE representing an amount of a current flowing through the MOSFET unit M2 and generates a current limiting signal SLI to the driving unit 210 according to the voltage detecting signal Va and the temperature detecting signal Ta.

The voltage detecting unit 230 includes a first voltage detecting device 232, a second voltage detecting device 234, and a starting delay device 236. The first voltage detecting device 232 generates an output voltage detecting signal Vb according to the output voltage VOUT. The second voltage detecting device 234 generates the voltage detecting signal Va to the current limiting unit 220 according to the output voltage detecting signal Vb and the input voltage VIN. When the input voltage VIN or the voltage drop between the input voltage VIN and the output voltage VOUT (i.e. the voltage drop across the drain and the source of the MOSFET unit M2) is raised, a current limiting value is reduced. Accordingly, it is ensured that the MOSFET unit M2 operates in the SOA.

Moreover, in starting or re-starting process, the output voltage VOUT is raised from zero. At the beginning of the starting or re-starting process, the voltage drop between the input voltage VIN and the output voltage VOUT is maximum, so that the current limiting value has the maximum reduction due to the large voltage drop across the drain and the source of the MOSFET unit M2. Accordingly, with the process in which the output voltage VOUT is gradually raised to be in a stable situation, the voltage drop between the input voltage VIN and the output voltage VOUT is gradually reduced, so that the current limiting value is gradually raised. The process is similar to a soft start mode. However, for some circuits, while being started or re-started, they may be required to raise the output voltage VOUT to the predetermined output voltage value as soon as possible. In this case, to reduce the current limiting value does not satisfy the requirement of such a circuit. Accordingly, as the present embodiment, the current limiting unit 220 does not adjust the current limiting value according to the output voltage VOUT for a predetermined period beginning from starting the circuit. As a result, for the predetermined period beginning form starting or re-starting the circuit, the current limiting value is not adjusted with the change of the output voltage VOUT, so that the time for that the output voltage VOUT reaches the predetermined voltage value is shortened.

Accordingly, when a current flowing through the MOSFET unit M2 reaches to the current limiting value, the current limiting unit 220 generates a current limiting signal SLI to the driving unit 210 to control the current of the MOSFET unit M2 inside the current limiting value. The current limiting unit 220 adjusts the current limiting value according to the voltage detecting signal Va and the temperature detecting signal Ta, so that when the temperature, the input voltage VIN, or/and the voltage drop across the drain and the source of the MOSFET unit M2 is/are raised, the current limiting value falls down therewith.

FIG. 5 is a schematic diagram illustrating that the predetermined current limiting value changes with the temperature and the voltage drop across the drain and the source of the MOSFET unit M2, wherein the vertical axis is the current limiting value of the MOSFET unit, and the horizontal axis is the temperature or the voltage drop. The dotted line a shows a possible method for adjusting the current limiting value in which the current limiting value falls down in a step-like manner with the raise of the temperature or the voltage drop. The solid line b shows another possible method for adjusting the current limiting value in which the current limiting value falls down in a linear manner with the raise of the temperature or the voltage drop.

To sum up, the current limiting value is adjusted to become lower with the raise of the temperature or the voltage drop in the embodiments consistent with the invention. Accordingly, it is ensured that the MOSFET unit operates in the SOA in any situation. Therefore, the MOSFET unit is prevented from being burnt out, and the reliability of the product is also increased.

As the above descriptions, the invention completely complies with the patentability requirements: novelty, non-obviousness, and utility. It will be apparent to those skilled in the art that various modifications and variations can be made to the structure of the invention without departing from the scope or spirit of the invention. In view of the foregoing descriptions, it is intended that the invention covers modifications and variations of this invention if they fall within the scope of the following claims and their equivalents.

What is claimed is:

1. A metal-oxide-semiconductor field effect transistor (MOSFET) current limiting circuit, comprising:
a MOSFET driving unit coupled to a MOSFET and controlling a state of the MOSFET; and
a current limiting unit configured to limit a current flowing through the MOSFET inside a current limiting value, wherein the current limiting value is adjusted according to a voltage drop across a drain and a source of the MOSFET.

2. The MOSFET current limiting circuit as claimed in claim 1, further comprising a temperature detecting unit configured to detect a temperature of the MOSFET driving unit or the MOSFET, so as to generate a temperature detecting signal, wherein the current limiting value is further adjusted according to the temperature detecting signal.

3. The MOSFET current limiting circuit as claimed in claim 2, wherein the current limiting value falls down in a linear manner or in a step-like manner while the temperature is raised up.

4. The MOSFET current limiting circuit as claimed in claim 1, wherein the current limiting value falls down in a linear manner or in a step-like manner while the voltage drop is raised up.

5. A linear voltage regulator, having a current limitation, comprising:
a MOSFET unit coupled to an input voltage and generating an output voltage according to a control signal;
a voltage feedback unit configured to detect the output voltage to generate a voltage feedback signal;
a driving unit configured to generate the control signal to stabilize the output voltage at a predetermined output voltage value according to the voltage feedback signal;
a voltage detecting unit generating a voltage detecting signal according to the input voltage; and
a current limiting unit configured to control the driving unit to limit a current of the MOSFET unit inside a current limiting value, wherein the current limiting value is adjusted according to the voltage detecting signal.

6. The linear voltage regulator as claimed in claim 5, wherein the current limiting value falls down in a linear manner or in a step-like manner.

7. The linear voltage regulator as claimed in claim 5, further comprising a temperature detecting unit configured to detect a temperature of the MOSFET unit, so as to generate a temperature detecting signal, wherein the current limiting value is further adjusted according to the temperature detecting signal.

8. The linear voltage regulator as claimed in claim 7, wherein the current limiting value falls down in a linear manner or in a step-like manner.

9. The linear voltage regulator as claimed in claim 5, wherein the voltage detecting unit generates the voltage detecting signal further according to the output voltage.

10. The linear voltage regulator as claimed in claim 9, wherein the current limiting value falls down in a linear manner or in a step-like manner.

11. The linear voltage regulator as claimed in claim 9, wherein the current limiting value is not adjusted with the output voltage during a predetermined period beginning from the linear voltage regulator being started or re-started.

12. The linear voltage regulator as claimed in claim 11, wherein the current limiting value falls down in the linear manner or in the step-like manner.

13. A voltage converting circuit, having a current limitation, comprising:
a converting circuit configured to convert an input voltage to an output voltage;
a voltage feedback unit configured to detect the output voltage to generate a voltage feedback signal;
a MOSFET unit coupled to the converting circuit; and
a control unit controlling the MOSFET unit to decide an amount of electric power inputted from the input voltage to the converting circuit according to the voltage feedback signal and to limit a current flowing through the MOSFET unit inside a current limiting value, wherein the current limiting value is adjusted according to a temperature of the control unit or the MOSFET unit.

14. The voltage converting circuit as claimed in claim 13, wherein the control unit comprises:
a driving unit configured to generate the control signal to stabilize the output voltage at a predetermined output voltage value according to the voltage feedback signal;
a temperature detecting unit configured to detect the temperature of the control unit or the MOSFET unit, so as to generate a temperature detecting signal; and
a current limiting unit coupled to the driving unit and controlling the driving unit according to a current detecting signal which is received by the current limiting unit and represents the current flowing through the MOSFET unit, so as to limit the current flowing through the MOSFET unit inside the current limiting value, wherein the current limiting value is adjusted according to the temperature detecting signal.

15. The voltage converting circuit as claimed in claim 14, wherein the current limiting value falls down in a linear manner or in a step-like manner.
